(19) United States
(12) Patent Application Publication
(10) Pub. No.: US 2019/0188781 A1
(43) Pub. Date: Jun. 20, 2019

(54) SYSTEMS AND METHODS FOR CONSERVING USER DEVICE RESOURCES DURING AN ONLINE OR VIRTUAL SHOPPING SESSION

(71) Applicant: Walmart Apollo, LLC, Bentonville, AR (US)

(72) Inventors: John J. O'Brien, Farmington, AR (US); David Tovey, Rogers, AR (US); Nicholas Ray Antel, Winona, MO (US); Steven J. Lewis, Bentonville, AR (US); John P. Thompson, Bentonville, AR (US); Todd D. Mattingly, Bentonville, AR (US)

(21) Appl. No.: 16/218,014

(22) Filed: Dec. 12, 2018

Related U.S. Application Data
(60) Provisional application No. 62/599,237, filed on Dec. 15, 2017.

(51) Int. Cl. G06Q 30/06; G06F 9/50; G06T 19/00

(52) U.S. Cl. CPC G06Q 30/0643; G06T 19/006; G06F 9/5044; G06F 9/505

(57) ABSTRACT

In some embodiments, apparatuses and methods are provided herein useful to adjustment of the display of a simulated online store on a user device based on computing usage at the user device. In some embodiments, the system includes: a shopping server for receiving a user request to view a simulated shopping environment; a user device resource module for determining the computing resource usage of the user device; and a control circuit for causing the display of simulated shopping images at the user device in an interactive simulation view, communicating with the user device resource module, determining a real time computing resource usage of the user device, and in certain circumstances, providing additional computing resources to display the simulated shopping environment at the user device at a first, higher consumption level or adjusting the display of the simulated shopping environment at the user device to a second, lower consumption level.

### CROSS-REFERENCE TO RELATED APPLICATION

This application claims the benefit of U.S. Provisional Application No. 62/599,237, filed Dec. 15, 2017, which is incorporated by reference in its entirety herein.

### TECHNICAL FIELD

This invention relates generally to conserving the computing demands on a user device, and more particularly, to conserving the computing demands on a user device during a virtual or online shopping session.

### BACKGROUND

In the retail setting, one area that is becoming of increasing significance is the virtual or online shopping environment. Some retailers have established an online shopping experience for customers in which the customer may participate in a realistic shopping experience without actually going to a store. Instead, the customer may access the retailer's website and navigate through a realistic appearing store that may have various departments and various types of products for sale.

In this virtual/online shopping environment, the computing demands may overwhelm the available computing resources and capabilities of the user device. For example, these computing demands may overwhelm the processing capabilities of the user device if the user device already has a number of demanding software applications running at the same time that may contribute to a significant user device load. It would therefore be desirable to allocation additional resources or adjust the display at the user device depending on the amount of the existing user device load.

### BRIEF DESCRIPTION OF THE DRAWINGS

Disclosed herein are embodiments of systems, apparatuses and methods pertaining to conserving computing resources and demands on a user device during a simulated shopping session. This description includes drawings, wherein:

FIG. 1 is a screenshot of an online shopping session in accordance with some embodiments;

FIG. 2 is a block diagram in accordance with some embodiments;

FIG. 3 is a screenshot of an online shopping session in accordance with some embodiments;

FIG. 4 is a screenshot of an online shopping session in accordance with some embodiments;

FIG. 5 is a screenshot of an online shopping session in accordance with some embodiments;

FIG. 6 is a block diagram in accordance with some embodiments;

FIG. 7 is a flow diagram in accordance with some embodiments;

FIG. 8 is a schematic diagram in accordance with some embodiments; and

FIGS. 9A and 9B show a flow diagram in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well- understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for providing a virtual/online shopping experience that conserves computing resources at a user device. In some embodiments, there is provided a system comprising: a shopping server configured to receive a user request from a user device to view a simulated shopping environment comprising a plurality of simulated shopping images, each image including one or more simulated objects; a user device resource module configured to determine the computing resource usage of the user device; and a control circuit configured to: cause the display of at least one of the plurality of simulated shopping images at the user device in an interactive simulation view to emulate a real-life shopping experience for the user, the simulated shopping images being transmitted from the shopping server to the user device during an online shopping session; cause communication with the user device resource module; determine a real time computing resource usage of the user device from the user device resource module; compare the real time computing resource usage of the user device with a predetermined limit; and if the real time computing resource usage exceeds the predetermined limit, provide additional computing resources from the shopping server to display the simulated shopping environment at the user device at a first, higher consumption level or adjust the display of the simulated shopping environment at the user device to a second, lower consumption level.

In the system, in some implementations, the user device resource module may be remote from the user device, the user device resource module configured to monitor the data transfer rate of data packets being transmitted from the shopping server to the user device. In some implementations, the user device resource module may be configured to monitor the data transfer rate by measuring the time required for a test file to be transmitted from the shopping server and downloaded by the user device. In some implementations, the user device resource module may comprise a plug-in device coupled to the user device or a task manager application at the user device, the user device resource module monitoring the computing resource usage of applications running at the user device. In some implementations, the adjustment of the display of the simulated shopping environment at the user device to a second, lower consumption level may comprise at least one of: reducing the number of simulated objects displayed at the user device; causing the display of at least one of the simulated objects at a reduced resolution; and limiting the types of items displayed at the user device to a predetermined group of display items corresponding to computing resource usage that does not exceed the predetermined limit. In some implementations, the control circuit may be configured to adjust the display of the simulated shopping environment at the user device in a prioritized manner, the control circuit configured to: first, limit the types of items displayed of the user device to simulated objects and text; second, cause the display of at least one of the simulated objects at a reduced resolution; and third, reduce the number of simulated objects displayed at the user device. In some implementations, the control circuit may be configured to determine if the real time computing resource usage exceeds the predetermined limit when the user device resource module measures a processing speed of the user device below a first predetermined percentage, a RAM usage by the user device in excess of a second predetermined percentage, a data transfer rate to the user device below a third predetermined amount of megabits per second (Mbps), or a latency by the user device greater than a fourth predetermined amount of milliseconds. In some implementations, the control circuit may be configured to: determine the real time computing resource usage of the user device at predetermined time intervals; and determine whether to allocate additional computing resources or adjust the display of the simulated shopping environment at each of these predetermined time intervals. In some implementations, the control circuit may be configured to: determine the real time computing resource usage of the user device at predetermined simulated shopping locations in the simulated shopping environment; and determine whether to allocate additional computing resources or adjust the display of the simulated shopping environment at each of these predetermined simulated shopping locations. In some implementations, the shopping server may be configured to transmit a 3D virtual reality shopping environment to the user device through a virtual reality interface. In some implementations, the system may further comprise: a first display unit that forms part of the user device; and a second display unit that is operatively coupled to the user device; wherein, if the real time computing resource usage of the user device exceeds the predetermined limit, the control circuit is configured to provide the user with the option to switch to the second display unit to display the simulated shopping at the first, higher consumption level.

In another form, there is provided a method for providing an online shopping experience that conserves computing resources, the method comprising: by a shopping server, receiving a user request from a user device to view a simulated shopping environment comprising a plurality of simulated shopping images, each image including one or more simulated objects; by a user device resource module, determining the computing resource usage of the user device; and by a control circuit: causing the display of at least one of the plurality of simulated shopping images at the user device in an interactive simulation view to emulate a real-life shopping experience for the user, the simulated shopping images being transmitted from the shopping server to the user device during an online shopping session; causing communication with the user device resource module; determining a real time computing resource usage of the user device from the user device resource module; comparing the real time computing resource usage of the user device with a predetermined limit; and if the real time computing resource usage exceeds the predetermined limit, providing additional computing resources from the shopping server to display the simulated shopping environment at the user device at a first, higher consumption level or adjusting the display of the simulated shopping environment at the user device to a second, lower consumption level.

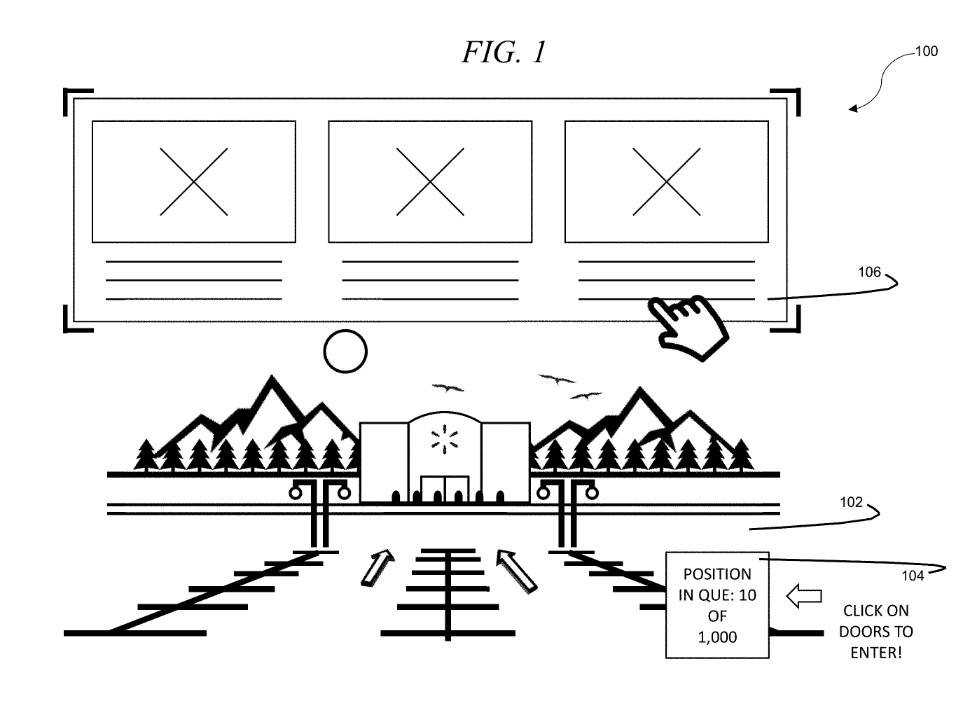

FIGS. 1-5 show one form of an online or virtual shopping experience. In this form, the customer/user may initially access a retailer (or other) website or software application to enter the online or virtual shopping environment. (The terms “customer” and “user” are generally used interchangeably herein.) It is contemplated that the customer may be given the option of various stores of the retailer, and the customer may then select a specific store for shopping. In one form, this option may involve the display of images of stores owned and/or operated by the retailer, and the user can then select one of the stores (such as by a cursor). It is generally contemplated that a customer may be able to login or logout of the customer's account from this initial portal. After choosing a store within this layout, the customer may then be directed to the store's online or virtual location, where the customer may be entered into a queue system, or may enter directly. In general, the terms “online” and “virtual” are used interchangeably herein to refer broadly to the generation of simulated shopping images and the creation of a realistic shopping experience without physically going to a store. In contrast, the term “virtual reality” refers generally to a 3D environment that is established through a virtual reality interface and other components.

Generally, as an overview, with the implementation of online environments being employed for shopping experiences, there is a concern that computer, server, and graphics rendering power demands on a user device may become too overwhelming. Such overwhelming power demands may crash or inhibit the operation of the user device or cause it to perform sluggishly. Overall, one focus herein is making an online or virtual reality shopping experience viable without demanding too much of the user device. FIGS. 1-5 show one example of an online or virtual shopping experience from both the server side (generating the shopping simulation images) and the user device side (displaying the shopping simulation images).

Referring to FIG. 1, in one form, there is shown a queue display screen 100 where the customer has entered the retailer's online or virtual shopping experience. In high-traffic situations, the customer may await entry into the online or virtual shopping experience at an online or virtual “parking lot,” where the customer's position in the queue is noted. As can be seen, in this form, the screen 100 may display an image of a retailer parking lot 102 and a wait sign 104 that may indicate the number of customers in the queue (and/or that may show an estimated wait time for entry). This “parking lot” allows for the controlled entry of customer into the online or virtual shopping experience so as to manage the number of customers and the demand on computing resources. This controlled entry seeks to prevent the sluggish response and possible disruption of the system.

This queue display screen 100 may also include a menu and/or banner portion 106 above the image of the parking lot 102. For example, this menu portion 106 may be used to display the following: a welcome back message; sales, special events, and/or reviews; user connections online (friends and family); messages from user connections or from the retailer; the status of delivery of items already ordered; a review section for previously purchased products; and/or account management features (such as login/logout, update account information, change payment method, delivery method, etc.). When the server is ready for the customer to enter into the shopping experience (the user has reached the front of the queue), the customer can then enter, and an online or virtual assistant may then assist the customer in navigating the retail environment (as described below).

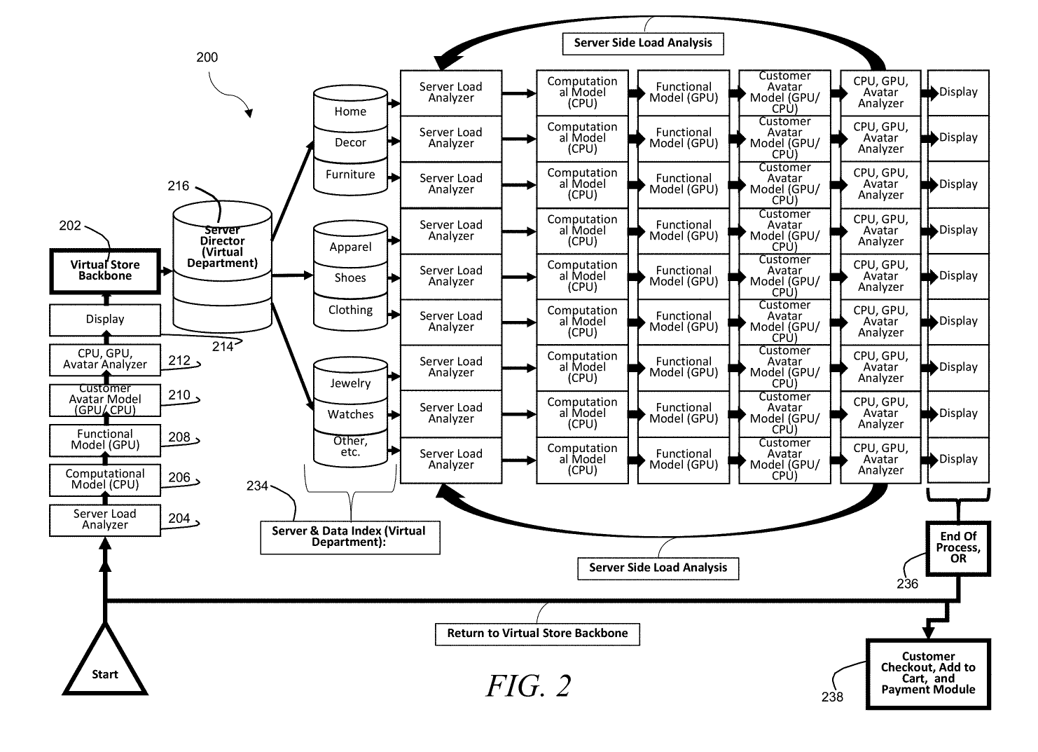

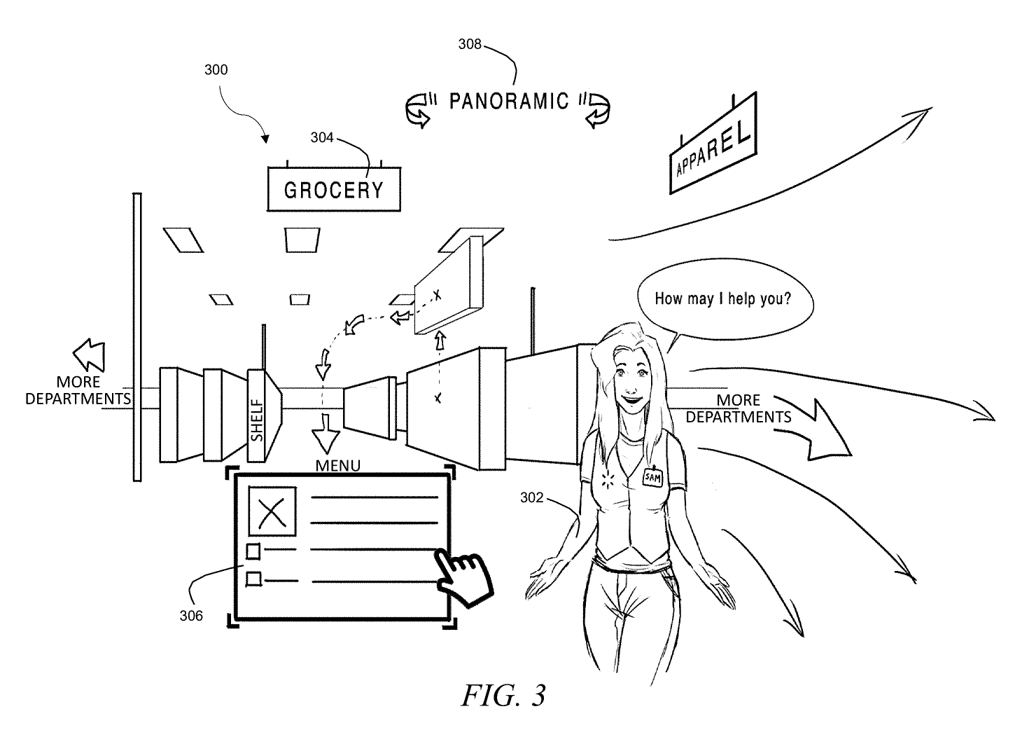

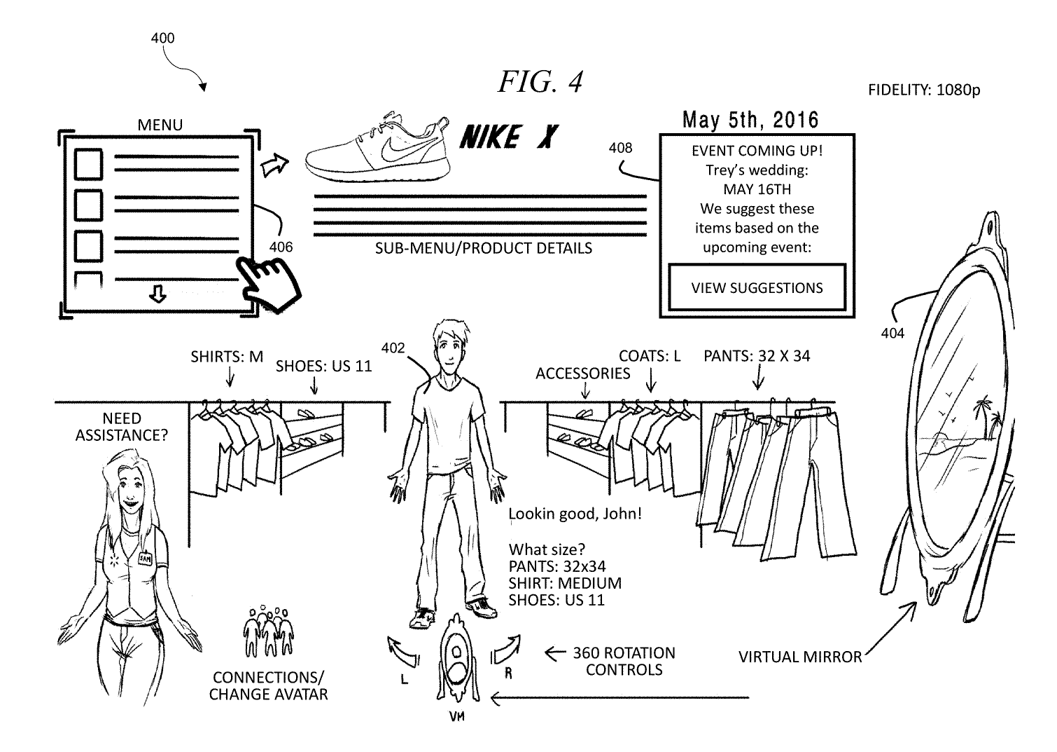

FIG. 2 shows a component model and process diagram 200 showing one example of a general system and workflow overview of the server side load analysis to try to prevent overload demands on the server side. In one form, an online or “virtual store backbone” 202 (also shown generally in one form in FIG. 3) allows the user to navigate through the online or virtual shopping environment to desired store departments. In essence, the virtual store backbone corresponds to general shopping areas, not specific store departments. In one form, the online or virtual store backbone 202 may include the following aspects and components: a server load analyzer 204; a computational model 206; a functional model 208; customer avatar model 210; and CPU/GPU/avatar analyzer 212. The online or virtual store backbone 202 may communicate with a display 214 of the user/customer. A server director 216 may allow selection of and navigation to a specific store department (such as shown in FIG. 4 and addressed below). For example, store departments may include: home, decor, furniture, apparel, shoes, clothing, jewelry, watches, etc. In turn, each store department may include a load analyzer (that may be subdivided into component load analyzers) for determining the computer usage demands by each store department.

In one form, the server load analyzer 204 may determine the load bearing on the server from the server director 216, server and data index 234, and the virtual store backbone 202. The server and data index 234 may include reference points for data and virtual department servers, which may be derived from physical points of location from the server, data, and virtual store backbone 202. In other words, this index 234 may indicate where to find information and where it resides. The server director 216 may split information from the online or virtual store backbone 202 and may send it to the server index (virtual department) 234. After the load bearing on these components has been determined, as well as the load bearing on the specified department(s), the server load analyzer 204 may send information to the computational model (CPU) 206, functional model (GPU) 208, and customer avatar model 210. The load bearing on these components may again be analyzed by the CPU/GPU/avatar analyzer 212, which may, in turn, be shared with the server load analyzer 204.

If the bearing on any of the components is such that the system suffers, the analyzer may set parameters on the components to create a stable online/virtual shopping experience on the server side. For instance, if there is a spike in traffic of users entering the online/virtual clothing department, the server load analyzer 204 may analyze this spike in traffic and bottleneck the online/virtual clothing department's components so the environment is stable. So, in this example, if there is a single user in the online/virtual clothing department and the load bearing on the components is not significant, the server load analyzer 204 may analyze this limited traffic and increase the online/virtual clothing department's components so the environment expressed is the highest fidelity available, such as, for example, 4K ultra-high definition.

In one form, it is contemplated that the system may generate a scalable display based on computer resource demands on the server side. Specific data may be gathered from the online or virtual store backbone 202, which may be rendered by computational, functional, and avatar models. The data may be analyzed for load bearing on the CPU, GPU, and server, and the display may then be scaled based on analysis by the server load analyzer. In other words, in a low-load bearing situation, high resolution or definition (such as, for example, 4K ultra-high definition) may be rendered for some or all of the display, while in a high-load bearing situation, a low resolution or definition (such as, for example, standard 720p high definition) may be rendered for some or all of the display.

Other aspects of the server side load analysis shown in diagram 200 are briefly described as follows. At the start block 201, a customer may enter the online or virtual store at the online/virtual store backbone 202. The computational model 206 may employ the use of computer processing units for mathematical computations, and different types of computational processors can interface with the functional models 208 and perform mathematical computations. The functional model 208 may employ the use of graphics processing units for rendering graphics, environments, products, etc., and, as indicated, graphics processing units may render graphics at different rates of fidelity depending on the load bearing of the components. The customer avatar model 210 may employ computer processing units and graphics processing units with the customer's inputs either from direct data inputs or from 3D scans of the customer's physical body as a 3D rendered avatar. The CPU, GPU, and avatar analyzer 212 may analyze the entire process stream before the display is rendered for determining if the fidelity should be increased or decreased as it relates to maintaining a stable online/virtual shopping experience. The display 214 is the final rendering of the shopping experience after all components have been used and analyzed for determining an optimal shopping experience while still maintaining its integrity. The end of process 236 may be one of the following: the endpoint of the shopping experience for the customer; the customer's decision and action to leave a specific department and return to the online/virtual store backbone 202; or the customer's decision and action to checkout, to add a purchase cart, and to begin the customer's transaction in the payment module 238. The customer can check out any selected items using the payment module 238 and the customer's preferred method of payment.

When the server is ready for the customer to enter into the shopping experience (such as from FIG. 1), the customer may be directed to a new screen 300. In one form, FIG. 3 shows an image of a screen 300 in which an online or virtual assistant 302 may offer to assist the customer in navigating the retail environment. From this screen, customers are able to select their preferred department or may simply ask the virtual assistant 302 for assistance in finding a product through a search query. As an example, in FIG. 3, the customer has asked for a specified product from the grocery department 304, and a menu 306 has been presented to the user. The menu 306 may feature the product, as well as similar products, specifications for the product, etc. The virtual assistant 302 may provide feedback on customer requests, assistance with navigation, shopping, or product information. Ultimately, this virtual assistant 302 may provide a friendly medium for interaction between the customer and the virtual shopping experience. Further, in one form, the customer's point of view may be changed by way of a panoramic adjuster 308 at the top of the figure, which may allow the customer to see the departments in any manner of his or her choosing.

FIG. 4 shows a screen 400 in which the customer has selected the online/virtual apparel department. It is generally contemplated that the customer may desire a higher resolution or definition when he or she interacts with certain types of products (such as, for example, apparel, shoes, watches, jewelry, cosmetics, etc.). These types of products generally require a more subjective judgment from the customer, so a higher resolution or definition may be desirable. In one form, it is contemplated that the customer may input measurements of the customer or a body scan to show how the customer avatar 402 appears in conjunction with the product.

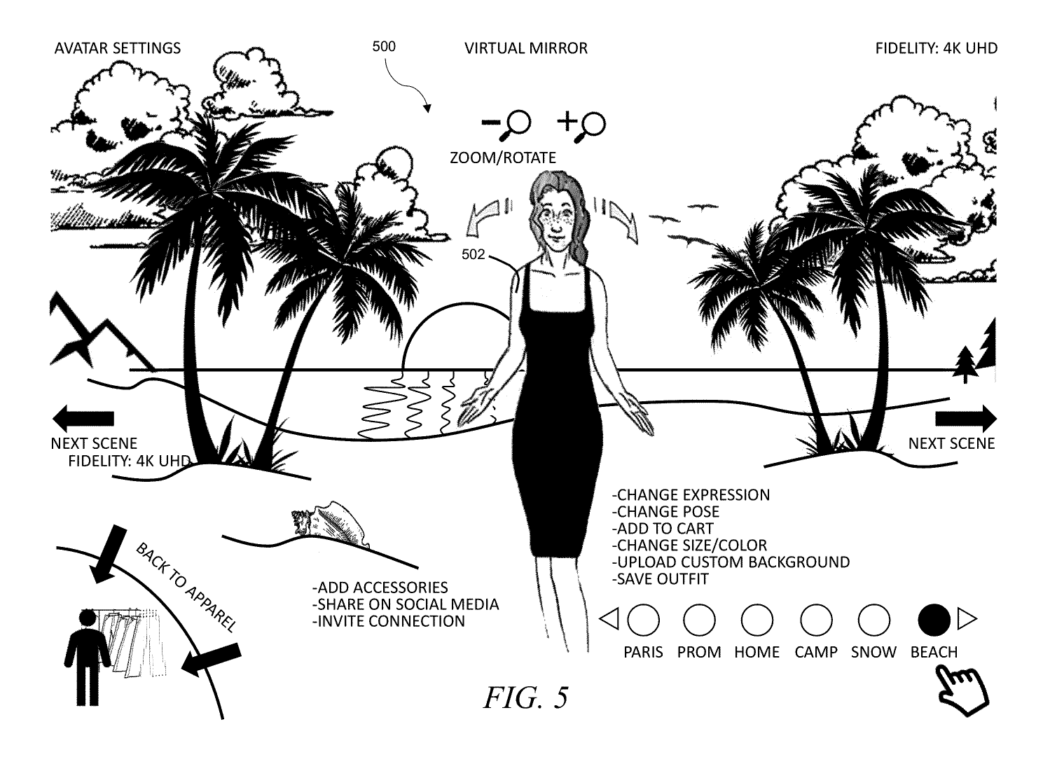

As can be seen in this example, the customer is provided with various apparel options, including shirts, pants, coats, shoes, and accessories. In FIG. 4, the customer has been prompted to input appropriate sizes/dimensions, and the customer may upload his or her own background. Although the assortments of apparel may be specific to the customer, such as shirt size, pant size, coat size, shoe size, etc., the sizing for the apparel may be changed by the customer as well. Apparel alterations can be made by the user, such as size, color, brand, etc. The customer's avatar 402 may then be displayed in conjunction with the selected items via a “virtual mirror” 404 (as described further below with reference to FIG. 5). From this online/ virtual dressing room, customers may be able to view apparel in the mirror 404. In one form, fidelity may increase within this online/virtual dressing room (to, for example, 1080p high definition resolution), but the system may employ limited, specific GPU, CPU, server, and other components to avoid overwhelming computer resource demands on the server side.

FIG. 4 shows additional options that may be included. For example, the customer may share his or her shopping experience with others via social media. The customer may invite other connections into the virtual shopping room, such as friends and family. In addition, in one form, the user may take a snapshot of the avatar 402 with given clothing, and possibly in a given environment, and then share it with others. For instance, if the customer is trying on a suit for an upcoming wedding, the customer could post images of the avatar 402 wearing the suit so he or she could receive feedback from others. Also, the customer could take a snapshot or some sort of image (or could save the layout) and store it for future viewing or sharing. FIG. 4 shows a menu 406 that may constitute a dynamic display featuring such items as brand, size, reviews, what friends, family, and connections have said about the apparel, etc. FIG. 4 further shows an event calendar 408 that may feature the date as well as the day's activities, and future events, such as a wedding, suggesting items of relevance for the specified occasion.

FIG. 5 shows a screen 500 that may be triggered when the customer uses the online/virtual mirror 404. It is generally contemplated that the avatar 502 can be manipulated to provide more information about interaction with the product, i.e., apparel. It is generally contemplated that the user may be provided with rotation of the avatar 502, zoom-in/ zoom-out of the avatar 502, a panoramic 360 degree viewing of the virtual template for the environment displayed within the virtual mirror 404, various poses and expressions, various changes in appearance (including but not limited to hair length, hair color, facial hair, cosmetics, earring, sunglasses, skin tone, etc.) It is further contemplated that the customer may be given the option to add accessories, share the experience on social media, take a screenshot or some sort of image that can be saved for later viewing, and/or invite other connections (such as friends and family) to allow guests to see the clothing worn by the avatar 502 and provide their feedback.

In one form, the customer may be provided with various backgrounds to provide context to the apparel worn by the avatar (or other interaction of the customer with a product). In FIG. 5, in this example, the predefined templates are identified as Paris, prom, camping, snow, and beach but may include other templates. The customer can toggle between different templates and may also upload the customer's own desired background. Fidelity may be increased in this setting (such as, for example, to 4K ultra-high definition resolution), but the system may employ limited, specific GPU, CPU, server, and other components to avoid overuse of computing resources. Users can navigate back to the virtual store, dressing room, or department, by clicking on the “back to apparel” option in the bottom-left quadrant of FIG. 5.

Accordingly, in one form, the simulated store seeks to create an environment wherein multiple phases and channels are used with an array of computer processors, graphics processors, and servers to create a stable virtual reality shopping environment on the server side that can be rendered at different resolutions throughout the experience. In some forms, where fidelity may need to be expressed with greater definition, such as in an online or virtual reality clothing department, this fidelity may be increased from the original fidelity (such as may be rendered at an online or virtual store mainframe). Alternatively, when the load bearing on a server experiences a spike in user traffic, the overall system may adjust its fidelity and other components to create a stable virtual shopping experience. In some forms, this stability may be achieved through use of a server load analyzer, as well as a CPU, GPU, and avatar analyzer. This server load analyzer may allow for a dynamic scaling of the rendering quality throughout the online or virtual shopping experience, as well as allowing for the intelligent monitoring of the consumption of resources employed by the online or virtual shopping experience on the server side.

In a primary aspect, this disclosure is directed to determining the computing resource usage and demands at the user device, i.e., at the user device side. In other words, in addition to evaluating the computing resource usage and processing demands on the server side, it is important to also evaluate the computing resource usage and processing demands at the user device side. If the software applications and other processing demands running at the user device are not evaluated, the display of images of the simulated store at the user device may be degraded, delayed, or result in sluggish operation (or non-functioning) of the user device. Therefore, it is desirable to evaluate the real time computing resource usage and processing demands at the user device prior to display of images of the simulated store at the user device.

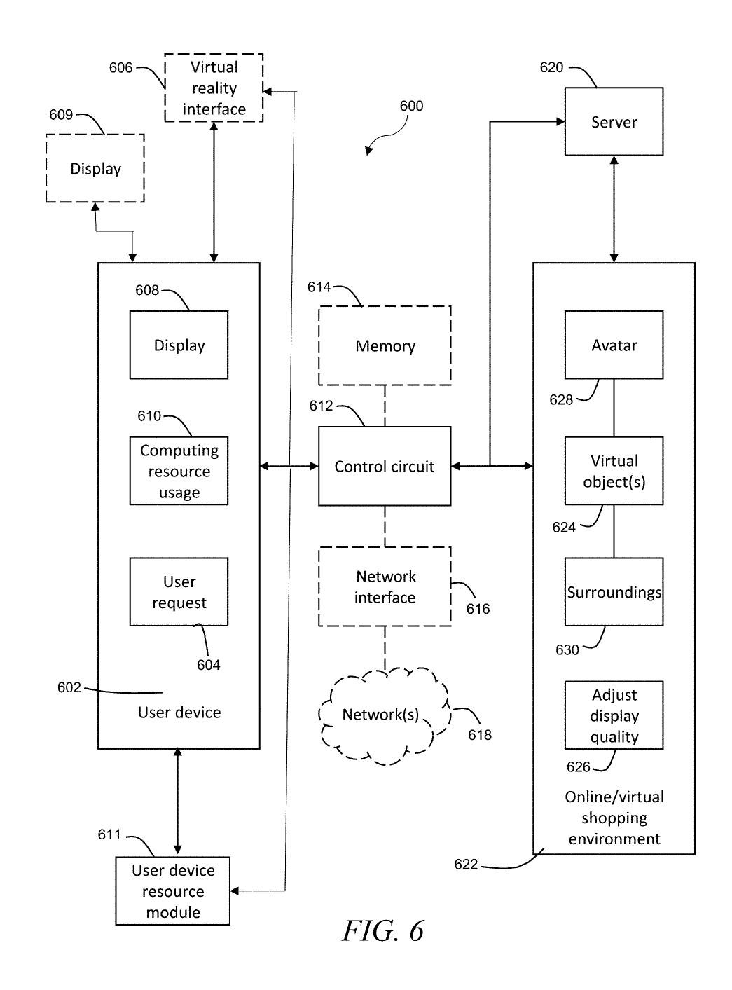

Referring to FIG. 6, there is shown a system 600 for analyzing the load at a user's device and taking appropriate action for displaying the virtual objects of a virtual/online shopping session at the user device. For example, based on computing resource usage at the user device, the system 600 may devote additional computer resources from the server side to avoid adjusting the display quality, or it may adjust the display quality of some or all of the virtual objects at the user device. It is generally contemplated that a user will initiate a virtual/online shopping session. As addressed further below, the display quality of certain virtual objects in the virtual/online shopping session may be adjusted, as appropriate, based on the measured computing resource usage at the user device.

As shown in FIG. 6, the user initiates the session via user device 602. It is contemplated that any form of user device 602 may be utilized, including, but not limited to, a desktop computer, laptop computer, tablet computer, or mobile computing device (smartphone, etc.). In one form, the user may initiate the session by accessing a retailer or other website (or software application) and transmitting a user login or request 604 (such as by clicking on a link on the website) to enter a virtual shopping environment. The shopping session may involve virtual reality (such as through the use of a virtual reality interface 606), but virtual reality is not required. The user device 602 includes a display 608 (a first display unit), and as addressed further below, there may be an adjustment of display quality 626 based on computing resource usage 610 at the user device 602.

The system 600 also includes a control circuit 612 that is communicatively coupled to the user device 602 and that generally controls the operation of the system 600. Being a “circuit,” the control circuit 612 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 612 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 612 is configured (for example, by using corresponding programming as will be well understood by those skilled in the art) to carry out one or more of the steps, actions, and/or functions described herein.

By one optional approach, the control circuit 612 operably couples to a memory 614. This memory 614 may be integral to the control circuit 612 or can be physically discrete (in whole or in part) from the control circuit 612, as desired. This memory 614 can also be local with respect to the control circuit 612 (where, for example, both share a common circuit board, chassis, power supply, and/or housing) or can be partially or wholly remote with respect to the control circuit 612 (where, for example, the memory 614 is physically located in another facility, metropolitan area, or even country as compared to the control circuit 612).

This memory 614 can serve, for example, to non-transitorily store the computer instructions that, when executed by the control circuit 612, cause the control circuit 612 to behave as described herein. As used herein, this reference to “non-transitorily” will be understood to refer to a non-ephemeral state for the stored contents (and hence excludes when the stored contents merely constitute signals or waves), rather than volatility of the storage media itself, and hence includes both non-volatile memory (such as read-only memory (ROM)) as well as volatile memory (such as an erasable programmable read-only memory (EPROM).)

In this example, the control circuit 612 also operably couples to a network interface 616. So configured, the control circuit 612 can communicate with other elements (both within the system 600 and external thereto) via the network interface 616. Network interfaces, including both wireless and non-wireless platforms, are well understood in the art and require no particular elaboration here. This network interface 616 can compatibly communicate via whatever network or networks 618 may be appropriate to suit the particular needs of a given application setting. Both communication networks and network interfaces are well understood areas of prior art endeavor and therefore no further elaboration will be provided here in those regards for the sake of brevity.

The system 600 further includes a shopping server 620 communicatively coupled to the control circuit 612. The shopping server 620 is configured to receive the user request 604 to view the simulated shopping environment 622, which comprises a plurality of simulated shopping images with each image including one or more simulated/virtual objects 624. Some examples of virtual objects 624 may include the virtual assistant 302 (in FIG. 3), avatars 402 or 502 (in FIGS. 4 and 5), or parts of the surroundings (such as menu 306 in FIG. 3).

The system 600 also includes a user device resource module 611 that is communicatively coupled to the control circuit 612. The user device resource module 611 is configured to determine the computing resource usage. As addressed further below, the module 611 may take any of various forms, but it is generally contemplated that the module 611 will make a determination of computing resource usage at the user device 602, either in general measurements (high vs. low usage) or in more precise numerical measurements. In turn, this determination of computing resource usage may be used by the system 600 to determine an appropriate action that might involve adjusting the display of the simulated shopping images at the user device 602.

So, for example, in one form, the user device resource module 611 may be remote from the user device 602 (possibly at the shopping server 620) and may monitor the data transfer rate to and/or from the user device 602. In other words, the user device resource module 611 may be configured to monitor the data transfer rate of data packets being transmitted from the shopping server 620 to the user device 602. The user device resource module 611 may be configured to monitor the data transfer rate by measuring the time required for a test file (or other files) to be transmitted from the shopping server 620 and downloaded by the user device 602. Bandwidth availability may be detected based on the speed of reception with a lower speed of reception (including packets not delivered or dropped) indicating a lower bandwidth. So, under one approach, the interaction between the shopping server 620 and user device 602, and the amount of delay in this interaction may be indicative of the computing resource usage and processing demands at the user device 602. In other words, a slower data transfer rate, i.e., a longer time lag in the interaction between module 611 and server 620, indicates greater real time computing resource usage at the user device 602, and as one possible response, it may be desirable to reduce the display quality of the simulated shopping images at the user device 602.

In another form, the user device resource module 611 may be located at the user device 602 and may monitor software applications running at the user device 620. For example, the user device resource module 611 may include a plug-in device (software or hardware) coupled to the user device 620, a dashboard add-on, or a task manager application at the user device 602 that monitor the computing resource usage of applications running at the user device 602. This local user device resource module 611 may share and distribute usage information to the shopping server 620. The user may provide access to such local user device resource modules 611 when logging in or submitting a user request to access the simulated shopping environment (or alternatively in response to a subsequent query after log in). As addressed further below, the user device resource module 611 may be configured to take a specific type of measurement to determine computing resource usage at the user device 602, which may then be compared to a threshold to determine appropriate action.

The control circuit 612 is configured to provide a virtual shopping experience for the user. More specifically, the control circuit 612 is configured to cause the display of simulated shopping image(s) at the user device 602 in an interactive simulation view to emulate a real-life shopping experience for the user in which the simulated shopping images are transmitted from the shopping server 620 to the user device 602 during the online shopping session. The control circuit 612 is further configured to take into account the computing resource usage at the user device 602. More specifically, as addressed further below, it communicates with the user device resource module 611, determines a real time computing resource usage 610 of the user device 602 from the user device resource module 611, compares the real time computing resource usage 610 of the user device 602 with a predetermined limit, and if the real time computing resource usage 610 exceeds the predetermined limit, provides additional computing resources from the shopping server 620 to display the simulated shopping environment at the user device 602 at a first, higher consumption level or adjusts the display of the simulated shopping environment at the user device 602 to a second, lower consumption level.

Real time computing resource usage 610 at the user device 602 may be determined by one or more load analyzers measuring a specific type of load at the user device 602. These load analyzers may perform one or more different possible analyzer checks for providing additional resources or adjusting the display at the user device 602. For example, the control circuit 612 may be configured to determine if the real time computing resource usage 610 exceeds the predetermined limit when the user device resource module 611 measures a processing speed of the user device 602 below a first predetermined percentage, a RAM usage by the user device 602 in excess of a second predetermined percentage, a data transfer rate to the user device below a third predetermined amount of megabits per second (Mbps), or a latency by the user device 602 greater than a fourth predetermined amount of milliseconds. So, there are a variety of different types of characteristics that may be measured to obtain an indication of real time computing resource usage 610.

In one form, depending on the type of characteristic being measured, it is contemplated that the system 600 may allocate additional computing resources in order to display the simulated shopping environment at the user device 602 as intended and without alteration. In other words, even though there may be an indication of high real time computing resource usage 610 at the user device 602, the control circuit 612 may allocate additional computing resources to display the simulated shopping environment without adjustment of the images. For example, if the user device CPU processing speed is below 30% (of normal operation), the control circuit 612 may allocate additional off-device processing and graphics rendering. As a second example, if the user device's RAM usage exceeds 60%, the control circuit 612 may allocate RAM to supplemental virtual machines for off-device processing and graphics rendering. It should be evident that these are just two examples of the allocation of additional resources and off-device processing that may be used, and other examples and limits for the allocation of additional resources are possible.

In another form, depending on the type of characteristic being measured, it is contemplated that the system 600 may adjust (or scale) the display of the simulated shopping environment at the user device 602. In other words, if there is an indication of high real time computing resource usage 610 at the user device 602, the control circuit 612 may adjust the display of images so as to conserve local computing resource usage at the user device 602. For example, if the data transfer rate (data load) or the latency of the user device 602 is at a certain threshold, the control circuit may adjust the display, such as by allocating compression processing and downscaling resources for delivery. The adjustment/scaling is triggered based on the status of the user device resources and a predetermined threshold. Further, this adjustment/scaling of the display may also be applied to the CPU and RAM usage characteristics addressed above and triggered when the CPU and RAM usage exceeds a certain threshold.

The adjustment of the display may be handled in various ways and may involve a prioritized approach. For example, adjustment of the display of the simulated shopping environment at the user device 602 may involve one or more of the following: reducing the number of simulated objects 624 displayed at the user device 602 (keeping the number of objects, for example, between 0 and 20 objects), causing the display of at least one of the simulated objects 624 at a reduced resolution (switching from a high resolution to a low or medium resolution), and limiting the types of items (such as objects, 3D images, text, links, video clips, etc.) displayed at the user device 602 to a certain group of display items. So, in one form, for instance, the display may be adjusted to show only a certain number of simulated objects (such as a maximum of 20 objects), reducing the resolution of the display from a high resolution (such as, for example, 4K ultra-high definition) to a low resolution (such as, for example, standard 720p high definition), and limiting the types of items displayed to text and other low processing types of items. Further, as another non-limiting example of prioritization, the control circuit 612 may be configured to adjust the display of the simulated shopping environment at the user device 602 in the following prioritized manner: first, limiting the types of items displayed at the user device to simulated objects and text; second, causing the display of at least one of the simulated objects at a reduced resolution; and third, reducing the number of simulated objects displayed at the user device.

The adjustment of display quality 626 may be in the form of a sliding scale of resolution settings. The adjustment of resolution may be scalable depending on the amount of real time computing power usage. In other words, the control circuit 612 may be configured to adjust the resolution of the virtual object(s) along a range of values between a low resolution limit and a high resolution limit in response to each determination of real time computing resource usage during the online shopping session. So, in one form, instead of being limited to two resolution settings, the display quality 610 may be adjusted along a continuum of resolution settings or may be adjusted between a certain discrete number of resolution settings. For example, the display quality may be adjustable between a total of four discrete resolution settings: a low resolution, a medium resolution, a high resolution, and a very high resolution. In another example, the scaling may be adjustment of the size of the virtual object(s) 624, such that the control circuit 612 may be configured to scale the display of the virtual object(s) 624 between a first size corresponding to a low power usage setting and a second size corresponding to a high power usage setting.

The virtual object(s) 624 whose display quality may be adjusted may include the avatar 628, the avatar's surroundings 630, or some combination or portions thereof. In others words, in one form, the virtual object 624 being adjusted may include an avatar 628 representing the user in the virtual shopping session, and the control circuit 612 may be configured to adjust the display of the avatar 628 or a portion of the avatar 628 between a low resolution and a high resolution. In another form, the virtual object 624 being adjusted may represent surroundings 630 near an avatar 628, and the control circuit 612 may be configured to adjust the display of the surroundings 630 or a portion of the environment between a low resolution and a high resolution.

Further, as described above, in one optional form, the shopping server 620 may be configured to transmit a 3D virtual reality shopping environment to the user device 602 through a virtual reality interface 606 and virtual reality system (but this is not required). For example, components of a virtual reality system may include a display device, a holographic display, an input device, audio devices, and motion sensors. The display device may present a virtual reality environment, and the user may utilize glasses to view and/or manipulate virtual products that appear to be in the user's hands. The glasses may be virtual reality glasses/goggles or augmented reality glasses/goggles. Additionally, the user may utilize haptic gloves (or other haptic devices, such as mats, sheets, objects, wearables, etc.) that simulate tactile sensations for products. In some embodiments, the holographic display may present products for the user to view and/or manipulate. Input devices may include a touchscreen, a touchpad, a keyboard, a mouse, or any other suitable input device or combination of input devices. Also, motion sensors may detect the user's movement and reorient images presented on the display device in a manner consistent with the user's movements. The motion sensors may also be used to allow the user to provide input via hand gestures or may track the user's eye movements. Additionally, the virtual reality shopping station may include one or more microphones to provide voice commands. This general description provides just one example of a virtual reality set-up, and it should be understood that any conventional virtual reality arrangement is suitable.

It is further contemplated that the load analysis of the user device 602 may be accomplished at various times. In one form, the load analysis may be checked and rechecked at certain specific time intervals, i.e., every minute. In other words, the control circuit 612 may be configured to determine the real time computing resource usage of the user device 602 at certain time intervals and to determine whether to allocate additional computing resources and/or adjust the quality of the display at each of these time intervals. In another form, the load analysis may be checked and rechecked at different virtual shopping locations. In other words, the control circuit 612 may be configured to determine the real time computing resource usage of the user device at certain online/virtual shopping locations in the simulated shopping environment 622 and to determine whether to allocate additional computing resources or adjust the quality of the display at each of these online/virtual shopping locations.

As an additional alternative, it is also contemplated that the user device 602 may make use of an additional display 609 to facilitate user viewing of the simulated shopping environment 622. In other words, the system 600 may include both a first display unit (display 608) that forms part of the user device 602 and a second display unit (display 609) that is operatively coupled to the user device 602, such that, if the real time computing resource usage of the user device 602 exceeds a certain limit (indicating high computing resource usage by the user device 602), the control circuit 612 may be configured to provide the user with the option to switch to the second display unit 609 to display the simulated shopping at the first, higher consumption level. For example, a user viewing a display on his or her smartphone at a reduced low resolution may be able to switch to a nearby computer/television monitor that is coupled to the smartphone, such as by Bluetooth or other wireless technologies, to view the display at a higher resolution.

In another alternative form, the user may be given the option to view the display at a lower display quality, regardless of the computing resource usage at the user device 602. The user may prefer not to have the system 600 devoting what may be a significant portion of the user device's processing capability to the simulated shopping environment 622. In other words, the control circuit 612 may apply a user preference (such as may be determined at a login of the user) to adjust the display of the simulated shopping environment 622 at the user device 602 to the second, lower consumption level, regardless of the real time computing resource usage 610 of the user device 602.

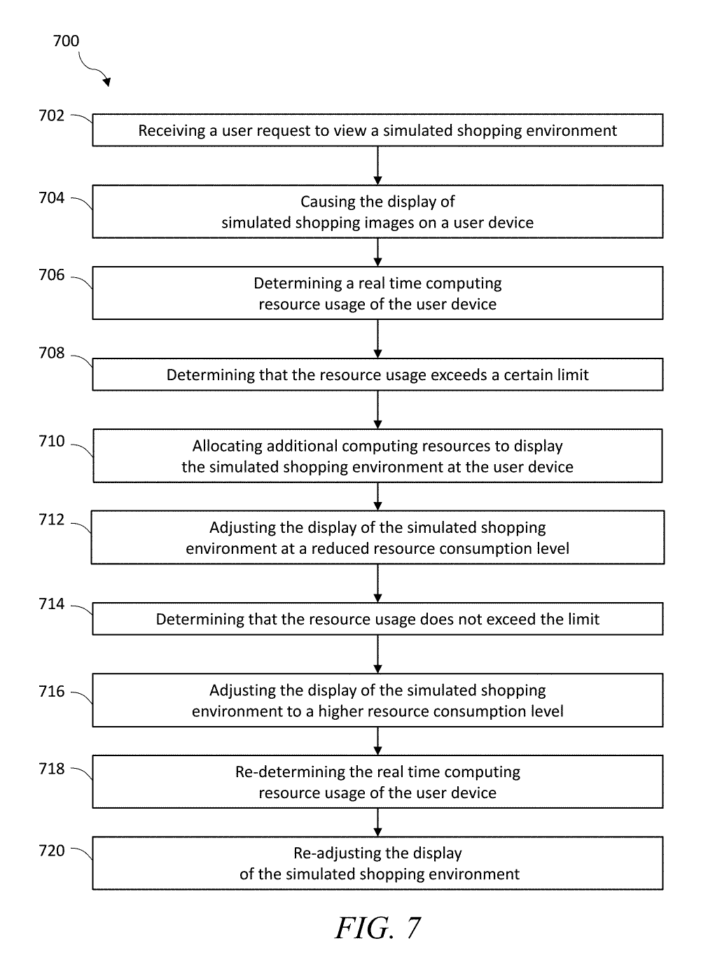

Referring to FIG. 7, there is shown a process 700 for analyzing the load at a user's device and taking appropriate action for displaying the virtual objects of a virtual/online shopping session at the user device. The process 700 generally involves receiving a login or request via the user device to participate in an online shopping session, and it is contemplated that the user can interact with and browse various store departments. The process 700 further involves allocating additional computing resources or adjusting display quality in order to avoid sluggish or discontinued response that may result from overwhelming resource usage demands. The process 700 may use some or all of the components described above with respect to system 600.

At block 702, a user login or request is received to view a simulated shopping environment. In one form, it is contemplated that the user may make this request after accessing a retailer website or software application. The user may be invited to participate in an online/virtual shopping session, and the user request may be in the form of accepting this invitation, such as by clicking on a link on the retailer website.

At block 704, the user request has been received and processed, and simulated shopping images are transmitted to and displayed on the user device. In one form, it is generally contemplated that the simulated shopping images may include virtual objects, such as avatars (representing the customer), virtual assistants (providing shopping assistance), menus (providing navigational guidance to the user), billboards (promoting or advertising certain products), etc. It is generally contemplated that the user will be able to interact with and navigate an interactive simulation view to emulate a real-life shopping experience for the user (such as shown, for example, in FIGS. 1 and 3-5).

At block 706, a real time computing resource usage at the user device is determined. It is generally contemplated that this usage is determined by a user device resource module, which may take various forms. For example, the user device resource module may be remote from the user device and may be located at the shopping server 620. In this form, the user device resource module may monitor the data transfer rate to and/or from the user device, such as by timing data packets or test files transmitted between the shopping server and user device. In another form, the user device resource module may be local to the user device. In this form, the local user device resource module may be a plug-in device, dashboard add-on, or task manager (or other) application monitoring software applications running at the user device. The real time computing resource usage of the user device may be determined according to different load analyzers and different characteristics. For example, the user device resource module may measure a processing speed of the user device, a RAM usage by the user device, a data transfer rate to the user device, or a latency by the user device.

At block 708, the computing resource usage at the user device is compared to a certain limit (which has been determined to indicate high computing resource usage). This limit may depend on which of the different types of load analysis is being performed. For example, the comparison may be based on whether the user device resource module measures a processing speed of the user device below a first predetermined percentage, a RAM usage by the user device in excess of a second predetermined percentage, a data transfer rate to the user device below a third predetermined amount of megabits per second (Mbps), or a latency by the user device 602 greater than a fourth predetermined amount of milliseconds. There are a variety of different types of load analysis checks that may be performed, and different specific circumstances may favor performing one load analysis check over the others.

At block 710, if the computing resource usage at the user devices exceeds the predetermined limit, additional computing resources may be allocated in order to display the simulated shopping environment at the user device without adjustment of the display. It is contemplated that this step may be an optional step in process 700 (as an alternative to block 712) and may depend on the specific load analysis characteristic being measured. For example, in one form, the computing resource usage may be measured based on processing speed (CPU) or based on RAM usage. In this example, the CPU or RAM may be allocated in such a manner to do additional off-device processing and graphics rendering. In some circumstances, in order to address high computing resource usage at the user device, it may be desirable that the process 700 include this allocation of additional resources to provide an unadjusted display, but in other circumstances, it may be desirable that the process 700 include adjustment of the display instead.

In block 712, as an alternative to block 710, if the computing resource usage at the user device exceeds the predetermined limit, the display of the simulated shopping environment is adjusted to a reduced resource consumption level. In other words, if there is an indication of high real time computing resource usage at the user device, the images may be displayed in an adjusted manner so as to conserve local computing resource usage at the user device. So, for example, if the data transfer rate to or latency by the user device is at a certain threshold, the display may be adjusted. It is contemplated that the display may be adjusted in variety of ways that may be prioritized in a preferred manner. For example, adjustment of the display may involve (in some preferred order): reducing the number of simulated objects displayed at the user device (up to a maximum of objects), causing the display of at least one of the simulated objects at a reduced resolution (low resolution), and limiting the types of items displayed at the user device to a certain group of display items (such as text only). Again, it is contemplated that this step may be an optional step in process 700 (as an alternative to block 710) and may depend on the specific load analysis characteristic being measured.

Next, at block 714, it may be determined that the resource usage does not exceed (or no longer exceeds) the threshold limit. This determination means that the processing and power demands on the system are not too great and need not be reduced. In fact, they may accommodate additional power demands, such as higher resolution or definition for the virtual object(s). At block 716, in response, the virtual object(s) in the images may be displayed at a higher resource consumption level because it may no longer be necessary to conserve computing resources (assuming the display was previously reduced to a low resource consumption level).

It is generally contemplated that this monitoring and comparison of the real time computing resource usage of the online shopping session is an iterative process. At block 718, the real time computing resource usage may be re-determined. It is generally contemplated that this re-determining (i.e., checking and re-checking the load analysis at the user device) may be accomplished in various ways, such as at specified time intervals and/or based on the user's navigation to certain store departments. At block 720, the display quality of the simulated shopping environment may be re-adjusted. In one form, for example, the resolution of some virtual object(s) may be increased or decreased in response to a comparison of the real time computing resource usage to a certain threshold.

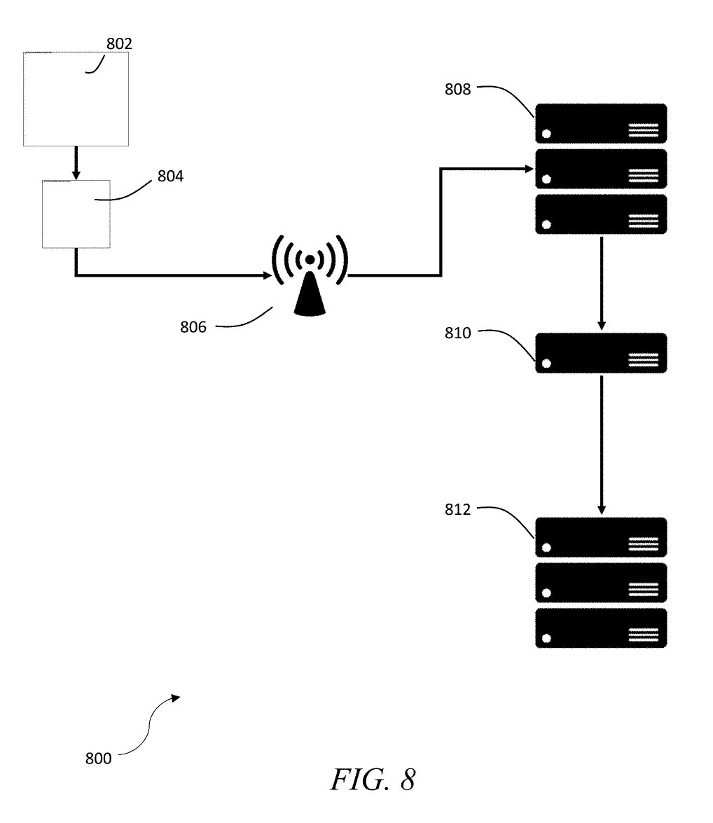

Referring to FIG. 8, there is shown a schematic diagram of a system 800 for analyzing the load at a user's device and, if the measured load is high, allocating additional resources on the server side to address this high load. For example, if the measured load is high (high computing resource usage at the user device), the system 800 may allocate additional computer resources to display the simulated shopping images without adjustment or to adjust the display quality in some manner. The system 800 may use some or all of the components described above with respect to system 600 and process 700.

As shown in FIG. 8, a user 802 accesses an online shopping session with simulated store images by a user device 804. As shown, one type of user device 804 that may be used is a smartphone, but it should be understood that any other suitable computing device may also be used (such as, for example, desktop computer, laptop computer, and tablet computers). As in system 600 described above, it is generally contemplated that the user 802 may access a retailer application or website and may send a user login or request to enter the simulated shopping environment. In this particular example, the user device 804 wirelessly communicates with the retailer server or website via wireless access point 806.

In addition, the user device 804 transmits certain characteristics of usage to the shopping simulation server(s) 808. In one form, it is contemplated that the user device 804 has some type of user device resource module that measures and determines the computing resource usage of the user device 804. As described above with respect to system 600 and process 700, the user device resource module may take various forms, such as, for example, a module that times data packets or test files transmitted between the user device 804 and shopping simulation server(s) 808, a plug-in (software or hardware) to the user device 804, dashboard add-on, or a task manager monitoring software applications running on the user device 804.

The user device resource module may be configured to measure any desired usage characteristic at the user device 804, such as, for example, CPU characteristics, memory availability, and network speeds associated with the user device 804. These usage characteristics are determined by and/or transmitted to the shopping simulation server(s) 808 via wireless access point 806. A shopping simulation load analyzer 810 then compares the desired usage characteristic to a certain threshold for that usage characteristic to determine if action needs to be taken. For example, the CPU capacity may be compared to a certain minimum threshold capacity, the memory usage may be compared to a certain maximum threshold usage, and the user network speeds may be compared to certain minimum speed threshold. In another example, more than one usage characteristic may be determined, and a load algorithm may be applied to the multiple usage characteristics. For example, if the CPU speed is less than 50% and the RAM usage is greater than 50% (of if either the CPU speed is less than 25% or the RAM usage is greater than 75%), then the algorithm triggers an adjustment of the display. If the threshold is exceeded or if the algorithm is triggered (indicating high computer resource usage at the user device 804), the virtual store backbone (or shopping simulation backbone) 812 (such as also shown by reference 202 in FIG. 2) allocates additional resources either: (1) to display the shopping simulation at the user device without adjustment; or (2) to display the shopping simulation with an adjusted display quality requiring fewer computing resources at the user device.

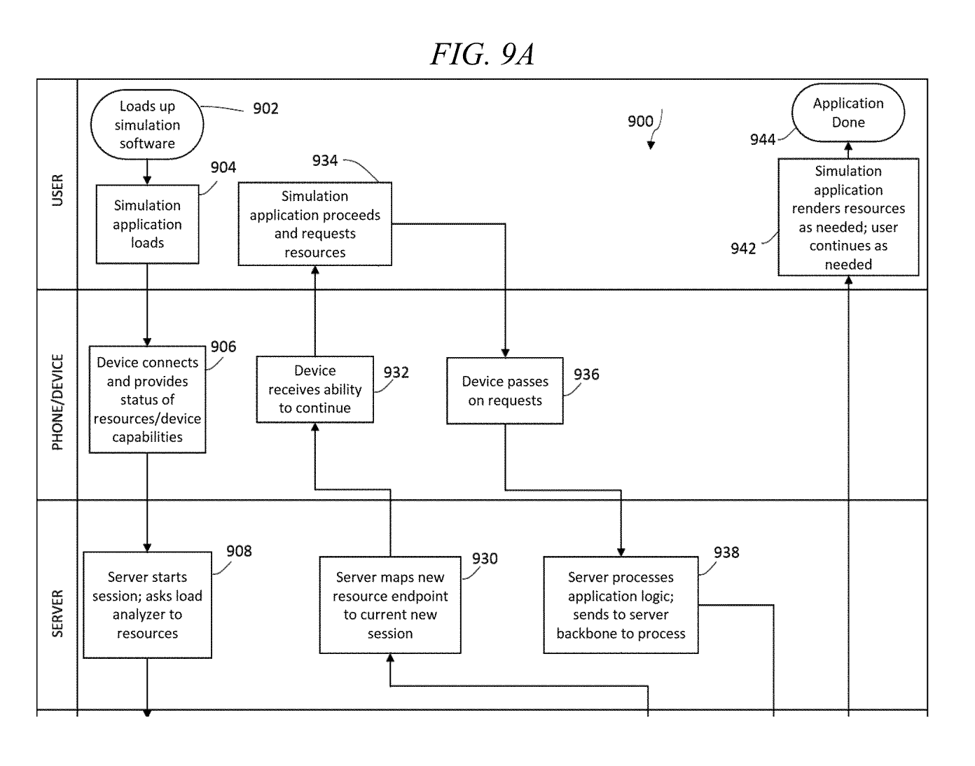

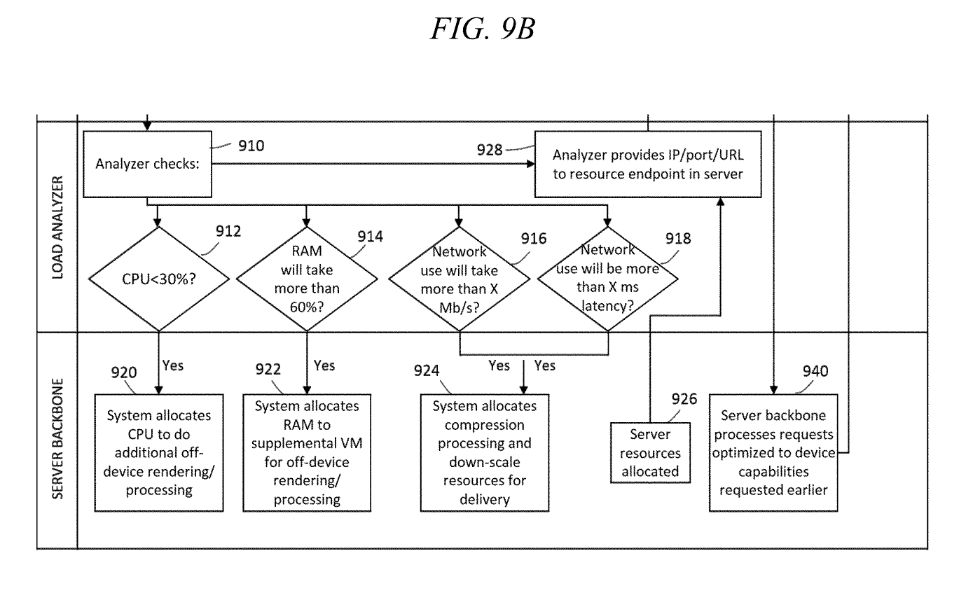

Referring to FIGS. 9A and 9B, there is shown a flow diagram for a process 900 for analyzing the load at a user's device and taking steps to conserve computing resources. If the user device load is too high (beyond a certain threshold or triggering a certain algorithm), the process 900 includes allocating additional computer resources so that the simulated shopping images can be displayed without adjustment (and without excessively burdening the user device) or can be displayed at a lower display quality level involving less computer resources. The process 900 may use some or all of the components described above with respect to systems 600 and 800 and process 700.

FIGS. 9A and 9B show actions and operations that are performed at or by a user, a phone/user device, a shopping simulation server, a shopping simulation load analyzer, and a shopping simulation backbone. As can be seen, at blocks 902 and 904, the user loads up the shopping simulation software and this software loads on the phone/user device. In this particular example, it is contemplated that the user may be on his or her smartphone and may be downloading a software application providing access to the shopping simulation server (although other user devices and manner of access may be used).

At block 906, the user device connects to the shopping simulation server and provides a status of the resources and the capabilities of the user device. In one form, it is contemplated that a user device resource module (such as any of the types described previously in this disclosure) provides the status of the resources. In one form, it is contemplated that this determination of the user device status may be initially performed when the user is logging into the shopping simulation session. At block 908, the shopping simulation server initiates the session and prompts the load analyzer to evaluate the resources of the user device to determine if action needs to be taken.

At block 910, one or more load analysis checks/comparisons are performed by the shopping simulation load analyzer. The load analysis check that is performed depends on which resource(s) of the user device are measured by the user device resource module. For example, at block 912, the CPU characteristics have been determined, and this CPU characteristic is compared against a 30% minimum threshold. As should be evident, other minimum threshold levels (such as 40% or 50%) may be selected as indicative of a high computing resource usage. As a second example, at block 914, the RAM availability has been determined, and this RAM availability is compared against a 60% threshold (although other thresholds may be selected as well). As a third example, at block 916, the user's network use is determined and compared to a maximum threshold of X Mb/s (megabits per second). As a fourth example, at block 918, it is determined whether the network use will exceed X ms (milliseconds) of latency. In one form, it is contemplated that just one of these usage characteristics will be compared to a certain threshold limit, and action will be taken if the threshold is exceeded. However, in another form, it is also contemplated that multiple usage characteristics may be determined and compared to certain thresholds, and action may be taken based on an algorithm giving a certain weight to each usage characteristic.

Blocks 920, 922, and 924 show different actions that are undertaken by the shopping simulation backbone. At block 920, if the CPU usage is below a certain limit (for example, 30%), then the backbone allocates additional off device rendering and processing. At block 922, if the RAM takes more than the maximum threshold (for example, 60%), then the backbone allocates RAM to supplemental virtual machines for off-device rendering and processing. In other words, at blocks 920 and 922, the backbone allocates additional processing and memory resources so that the display at the user device need not be adjusted.

Block 924 addresses action to be taken if the user's network use exceeds certain maximum thresholds, such as, for example, X Mb/s delay or X ms latency (see blocks 916 and 918). At block 924, if these thresholds are exceeded, the backbone allocates compression processing and down-scale resources for delivery to the user device, i.e., the display at the user device will be adjusted. The compression processing and down-scale resources may, for example, be in the form of reducing the number of simulated objects displayed at the user device (establishing a maximum number and type of objects), causing the display of at least one of the simulated objects at a reduced resolution (lower the resolution of some or all of the simulated objects), and limit the types of items displayed at the user device (display only text and objects, no video). Further, the compression processing and down-scale resources may be applied in a certain prioritized manner to reduce the usage characteristic(s) below desired threshold(s).

Other blocks show implementation and evaluation of the computing resource usage at the user device. At block 926, server resources are allocated, and at block 928, the shopping simulation analyzer provides an address (IP/port/URL) to a resource endpoint in the shopping simulation server. At block 930, the shopping simulation server maps the new resource endpoint to the user's current shopping session. At blocks 932, 934, and 936, the user device receives the ability to continue, the user and shopping simulation application request the resources, and the user device passes on the request. At blocks 938, 940, and 942, the shopping simulation server processes the application logic (and transmits to the backbone for processing), the backbone processes the request (which is preferably optimized to the capabilities of the user device), and the shopping simulation application renders the resources as needed. For example, a software application may be used to identify the type of user device and/or to evaluate the hardware capabilities of the user device. At block 944, the simulation application is ended (the shopping session is over). It is contemplated that the determination of computing resource usage is an iterative process and may be repeated at certain time intervals or certain locations within the shopping simulation environment.

The above description has generally addressed the measurement and evaluation of computing resource usage at the user device and actions that can be taken to display a virtual shopping environment to conserve computing resources. In one form, it is generally contemplated that this monitoring of user device load will be just one part of a larger overall system that also monitors server load. When either the user device load or the server load exceeds certain threshold(s), actions may be taken to conserve computing resources at the user device and/or at the server. Approaches for conserving computing resources based on server load are addressed in more detail in U.S. patent application Ser. Nos. 15/793,483 and 15/793,582, which have been assigned to the Applicant and are incorporated by reference herein in their entirety.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for providing an online shopping experience that conserves computing resources, the system comprising:
a shopping server configured to receive a user request from a user device to view a simulated shopping environment comprising a plurality of simulated shopping images, each image including one or more simulated objects;
a user device resource module configured to determine the computing resource usage of the user device;
a control circuit configured to:
cause the display of at least one of the plurality of simulated shopping images at the user device in an interactive simulation view to emulate a real-life shopping experience for the user, the simulated shopping images being transmitted from the shopping server to the user device during an online shopping session;
cause communication with the user device resource module;
determine a real time computing resource usage of the user device from the user device resource module;
compare the real time computing resource usage of the user device with a predetermined limit; and
if the real time computing resource usage exceeds the predetermined limit, provide additional computing resources from the shopping server to display the simulated shopping environment at the user device at a first, higher consumption level or adjust the display of the simulated shopping environment at the user device to a second, lower consumption level.

2. The system of claim 1, wherein the user device resource module is remote from the user device, the user device resource module configured to monitor the data transfer rate of data packets being transmitted from the shopping server to the user device.

3. The system of claim 2, wherein the user device resource module is configured to monitor the data transfer rate by measuring the time required for a test file to be transmitted from the shopping server and downloaded by the user device.

4. The system of claim 1, wherein the user device resource module comprises a plug-in device coupled to the user device or a task manager application at the user device, the user device resource module monitoring the computing resource usage of applications running at the user device.

5. The system of claim 1, wherein the adjustment of the display of the simulated shopping environment at the user device to a second, lower consumption level comprises at least one of:
reducing the number of simulated objects displayed at the user device;
causing the display of at least one of the simulated objects at a reduced resolution; and
limiting the types of items displayed at the user device to a predetermined group of display items corresponding to computing resource usage that does not exceed the predetermined limit.

6. The system of claim 1, wherein the control circuit is configured to adjust the display of the simulated shopping environment at the user device in a prioritized manner, the control circuit configured to:
first, limit the types of items displayed at the user device to simulated objects and text;
second, cause the display of at least one of the simulated objects at a reduced resolution; and
third, reduce the number of simulated objects displayed at the user device.

7. The system of claim 1, wherein the control circuit is configured to determine if the real time computing resource usage exceeds the predetermined limit when the user device resource module measures a processing speed of the user device below a first predetermined percentage, a RAM usage by the user device in excess of a second predetermined percentage, a data transfer rate to the user device below a third predetermined amount of megabits per second (Mbps), or a latency by the user device greater than a fourth predetermined amount of milliseconds.

8. The system of claim 1, wherein the control circuit is configured to:
determine the real time computing resource usage of the user device at predetermined time intervals; and
determine whether to allocate additional computing resources or adjust the display of the simulated shopping environment at each of these predetermined time intervals.

9. The system of claim 1, wherein the control circuit is configured to:
determine the real time computing resource usage of the user device at predetermined simulated shopping locations in the simulated shopping environment; and
determine whether to allocate additional computing resources or adjust the display of the simulated shopping environment at each of these predetermined simulated shopping locations.

10. The system of claim 1, wherein the shopping server is configured to transmit a 3D virtual reality shopping environment to the user device through a virtual reality interface.

11. The system of claim 1, further comprising:
a first display unit that forms part of the user device;
a second display unit that is operatively coupled to the user device;
wherein, if the real time computing resource usage of the user device exceeds the predetermined limit, the control circuit is configured to provide the user with the option to switch to the second display unit to display the simulated shopping environment at the first, higher consumption level.

12. A method for providing an online shopping experience that conserves computing resources, the method comprising:
by a shopping server, receiving a user request from a user device to view a simulated shopping environment comprising a plurality of simulated shopping images, each image including one or more simulated objects;
by a user device resource module, determining the computing resource usage of the user device;
by a control circuit:
causing the display of at least one of the plurality of simulated shopping images at the user device in an interactive simulation view to emulate a real-life shopping experience for the user, the simulated shopping images being transmitted from the shopping server to the user device during an online shopping session;
causing communication with the user device resource module;
determining a real time computing resource usage of the user device from the user device resource module;
comparing the real time computing resource usage of the user device with a predetermined limit; and
if the real time computing resource usage exceeds the predetermined limit, providing additional computing resources from the shopping server to display the simulated shopping environment at the user device at a first, higher consumption level or adjusting the display of the simulated shopping environment at the user device to a second, lower consumption level.

13. The method of claim 12, further comprising, by the user device resource module, monitoring the data transfer rate of data packets being transmitted from the shopping server to the user device.

14. The method of claim 13, further comprising, by the user device resource module, measuring the time required for a test file to be transmitted from the shopping server and downloaded by the user device.

15. The method of claim 12, further comprising, by the user device resource module, monitoring the computing resource usage of applications running at the user device.

16. The method of claim 12, wherein the adjusting of the display of the simulated shopping environment at the user device to a second, lower consumption level comprises at least one of:
reducing the number of simulated objects displayed at the user device;
causing the display of at least one of the simulated objects at a reduced resolution; and
limiting the types of items displayed at the user device to a predetermined group of display items corresponding to computing resource usage that does not exceed the predetermined limit.

17. The method of claim 12, further comprising, by the control circuit, adjusting the display of the simulated shopping environment at the user device in a prioritized manner, the control circuit:
first, limiting the types of items displayed at the user device to simulated objects and text;
second, causing the display of at least one of the simulated objects at a reduced resolution; and
third, reducing the number of simulated objects displayed at the user device.

18. The method of claim 12, further comprising, by the control circuit, determining if the real time computing resource usage exceeds the predetermined limit when the user device resource module measures a processing speed of the user device below a first predetermined percentage, a RAM usage by the user device in excess of a second predetermined percentage, a data transfer rate to the user device below a third predetermined amount of megabits per second (Mbps), or a latency by the user device greater than a fourth predetermined amount of milliseconds.

19. The method of claim 12, further comprising, by the control circuit:
determining the real time computing resource usage of the user device at predetermined time intervals; and
determining whether to allocate additional computing resources or adjust the display of the simulated shopping environment at each of these predetermined time intervals.

20. The method of claim 12, further comprising, by the control circuit:
determining the real time computing resource usage of the user device at predetermined simulated shopping locations in the simulated shopping environment; and
determining whether to allocate additional computing resources or adjust the display of the simulated shopping environment at each of these predetermined simulated shopping locations.

21. The method of claim 12, wherein the shopping server is configured to transmit a 3D virtual reality shopping environment to the user device through a virtual reality interface.

22. The method of claim 12, further comprising:
providing a first display unit that forms part of the user device;
providing a second display unit and operatively coupling it to the user device; and
by the control circuit, if the real time computing resource usage of the user device exceeds the predetermined limit, providing the user with the option to switch to the second display unit to display the simulated shopping environment at the first, higher consumption level.

23. The method of claim 12, further comprising, by the control circuit, applying a user preference to adjust the display of the simulated shopping environment at the user device to the second, lower consumption level regardless of the real time computing resource usage of the user device.
